(19) United States
(12) Patent Application Publication
(10) Pub. No.: US 2010/0259532 A1
(43) Pub. Date: Oct. 14, 2010

(54) Display device and display driving method

(75) Inventors: Satoshi Tatara, Kanagawa (JP); Masatsugu Tomida, Kanagawa (JP); Naobumi Toyomura, Kanagawa (JP); Katsuhide Uchino, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/659,426

(22) Filed: Mar. 9, 2010

(30) Foreign Application Priority Data
Apr. 8, 2009 (JP) 2009-093952

(51) Int. Cl. G06F 3/038

(52) U.S. Cl. 345/213; 345/214

(57) ABSTRACT

Disclosed herein is a display device including: a pixel array configured to include pixel circuits that are arranged in a matrix and each have at least a light emitting element, a switching transistor for inputting a signal value supplied to a signal line, and a drive transistor for current application to the light emitting element dependent on the input signal value; a signal value output unit configured to output signal values given to the pixel circuits in the pixel array to the signal lines disposed on the pixel array; and a write controller configured to give, to the pixel circuits on a line-by-line basis, scan pulses for carrying out conduction control of the switching transistor and inputting the signal value on the signal line to the pixel circuit, and allow the scan pulses given to lines to each have a pulse waveform set depending on mobility of the drive transistors in a corresponding one of the lines of the pixel array.

### BACKGROUND OF THE INVENTION

1. Field of the Invention

The present invention relates to a display device having a pixel array in which pixel circuits each having a light emitting element are arranged in a matrix, and a display driving method thereof.

2. Description of the Related Art

Related arts of the present invention are described in e.g. Japanese Patent Laid-open No. 2008-158377 (Patent Document 1) and Japanese Patent Laid-open No. 2008-40024 (Patent Document 2).

In an active-matrix display device in which organic electroluminescence (EL) light emitting elements are used for the pixels, the current that flows through the light emitting element in each pixel circuit is controlled by an active element (in general, thin film transistor (TFT)) provided inside the pixel circuit. That is, because the organic EL element is a current light emitting element, the grayscale of the color of light emission is obtained by controlling the amount of current that flows through the EL element.

At the early stage of the development of the active organic EL display, the low-temperature poly-silicon TFT, which can ensure the drive current, is mainly studied. In the study, variation in the characteristics of the drive transistor among the pixels is regarded as the biggest problem, and various pixel circuits for correcting the variation have been proposed.

Presently, this problem is substantially solved and it is becoming possible to obtain a display in which sufficient in-plane uniformity is ensured. However, it is difficult for the low-temperature poly-silicon TFT to allow increase in the size of the substrate glass, and development of a system that employs the amorphous silicon (a-Si) TFT, which easily allows increase in the substrate size, in the drive circuit for the organic EL element is becoming active.

However, the amorphous silicon TFT has a problem that its threshold variation is large, and how to solve this problem is an issue.

FIG. 17 is a diagram represented by plotting the mobility on the abscissa and plotting variation in the threshold (ΔVth) on the ordinate. The amorphous silicon TFT is lower than the low-temperature poly-silicon TFT in the mobility and is larger than the low-temperature poly-silicon TFT in the threshold variation.

In the case of use for a large-size television set, there is a margin in the transistor size because the pixel pitch can be set comparatively large, and thus so high mobility is not necessary. Therefore, even the amorphous silicon TFT having low mobility causes no problem in this point. However, the threshold variation needs to be sufficiently small, and thus the amorphous silicon TFT is disadvantageous in this point.

On the other hand, the micro-silicon (μ-silicon: microcrystalline silicon) TFT is useful as a transistor that has small threshold variation and is higher than the amorphous silicon TFT in the mobility.

### SUMMARY OF THE INVENTION

As one of process techniques for the μ-Si TFT, an annealing technique (raster laser scan) that employs a high-power-output semiconductor laser and is called diode laser thermal annealing (dLTA) has been developed. In this technique, an a-Si film is annealed by a laser diode to thereby form a microcrystalline Si film.

This process is not restricted by the glass substrate size.

However, if this method is carried out by a single laser head, the scan takes a long time. By performing the scan by using plural laser heads simultaneously, the number of steps can be reduced corresponding to the number of laser heads used.

Presently, the development of a process technique with use of plural laser heads is being promoted. However, if the annealing is performed by laser from plural different laser heads, variation in the mobility of the TFT arises because variation occurs in the power output of the laser. This results in a problem of variation in the luminance in the direction perpendicular to the raster laser scan direction.

This variation is schematically shown in FIG. 18. Specifically, FIG. 18 shows a panel obtained by performing raster laser scan in such a way that 20 lines are simultaneously scanned by one laser head and this one scan for 20 lines is regarded as one unit. Unit #1 denotes the part scanned by a first laser head. Unit #2 denotes the part scanned by a second laser head. Unit #3 denotes the part scanned by a third laser head.

When a video signal for providing the same luminance in the entire screen range is given to the display panel manufactured by using these three laser heads, luminance unevenness like that shown in the diagram occurs. The unevenness is exaggeratingly shown in the diagram. However, in practice, variation in the mobility of the TFT occurs among the parts annealed by the different laser heads. As a result, luminance unevenness on a unit-by-unit basis like that shown in the diagram occurs.

On the other hand, the above-cited Patent Document 1 proposes a method in which the amount of rise of the source potential of the drive transistor is adjusted by changing the capacitor added to the organic EL element and luminance variation is adjusted for suppressing screen shading. However, in this case, the capacitor may not often be disposed in the pixel if the capacitor added to the organic EL element is set larger.

Patent Document 2 proposes a method in which the layout of the TFT is changed corresponding to mobility variation to thereby address luminance variation. Specifically, the L-length of the TFT is set short and the W-length thereof is set long in a unit involving low mobility, whereas the L-length of the TFT is set long and the W-length thereof is set short in a unit involving high mobility. However, easy responding is difficult if the mobility of the unit differs from panel to panel.

There is a need for the present invention to eliminate luminance unevenness attributed to variation in the mobility from unit to unit like that shown in FIG. 18 and propose a scheme that does not desire layout change of the pixel structure and can easily respond to panels involving various kinds of mobility variation.

According to a mode of the present invention, there is provided a display device including a pixel array configured to include pixel circuits that are arranged in a matrix and each have at least a light emitting element, a switching transistor for inputting a signal value supplied to a signal line, and a drive transistor for current application to the light emitting element dependent on the input signal value, a signal value output unit configured to output signal values given to the pixel circuits in the pixel array to the signal lines disposed on the pixel array, and a write controller configured to give, to the pixel circuits on a line-by-line basis, scan pulses for carrying out conduction control of the switching transistor and inputting the signal value on the signal line to the pixel circuit, and allow the scan pulses given to lines to each have a pulse waveform set depending on the mobility of the drive transistors in a corresponding one of the lines of the pixel array.

In the display device, the lines of the pixel circuits included in the pixel array may be subjected to laser annealing treatment by laser scan by use of a plurality of laser heads in a manufacturing process, and the mobility of the drive transistor may be measured for each of units that are each composed of a plurality of lines subjected to the laser annealing treatment by the same laser head. Furthermore, the write controller may carry out pulse waveform setting for the scan pulses for each of the units depending on the mobility measured for each of the units.

For example, the write controller may carry out pulse width setting dependent on the mobility as the pulse waveform setting for the scan pulses. Alternatively, the write controller may carry out pulse voltage level setting dependent on the mobility.

In this mode of the present invention, the pulse waveform (the pulse width or the pulse voltage level) of the scan pulse for the signal value writing for the pixel circuit is made different e.g. on a unit-by-unit basis. This means that the time of the signal value writing and the mobility correction or the speed of the signal value writing is so adjusted that the mobility correction for the drive transistor at the time of the signal value writing results in an equivalent corrected state for all of the units.

The mode of the present invention allows video displaying free from luminance difference even when variation in the mobility from line to line exists. In particular, the mode of the present invention allows video output free from luminance difference even when mobility variation attributed to annealing treatment by plural laser heads exists.

### BRIEF DESCRIPTION OF THE DRAWINGS

FIG. 1 is a block diagram of a display device according to an embodiment of the present invention;

FIG. 2 is a circuit diagram of a pixel circuit of the embodiment;

FIG. 3 is an explanatory diagram of the operation of the pixel circuit of the embodiment;

FIG. 4 is an explanatory diagram of mobility correction of the embodiment;

FIG. 5 is an explanatory diagram of a write scanner for controlling the pixel circuits of the embodiment;

FIG. 6 is an explanatory diagram of units and monitoring TFTs of the embodiment;

FIGS. 7A and 7B are explanatory diagrams of mobility measurement of the embodiment;

FIG. 8 is an explanatory diagram of scan pulses of a first embodiment of the present invention;

FIG. 9 is an explanatory diagram of write control of the first embodiment;

FIG. 10 is an explanatory diagram of pulse width setting of the first embodiment;

FIG. 11 is an explanatory diagram of the relationship between the writing time and the mobility relating to the pulse width setting of the first embodiment;

FIG. 12 is an explanatory diagram of scan pulses of a second embodiment of the present invention;

FIG. 13 is an explanatory diagram of write control of the second embodiment;

FIGS. 14A and 14B are explanatory diagrams of pulse voltage level setting of the second embodiment;

FIGS. 15A and 15B are explanatory diagrams of the writing speed dependent on the pulse voltage of the second embodiment;

FIG. 16 is an explanatory diagram of the pulse voltage level setting of the second embodiment;

FIG. 17 is an explanatory diagram of the threshold variation and mobility of TFTs; and

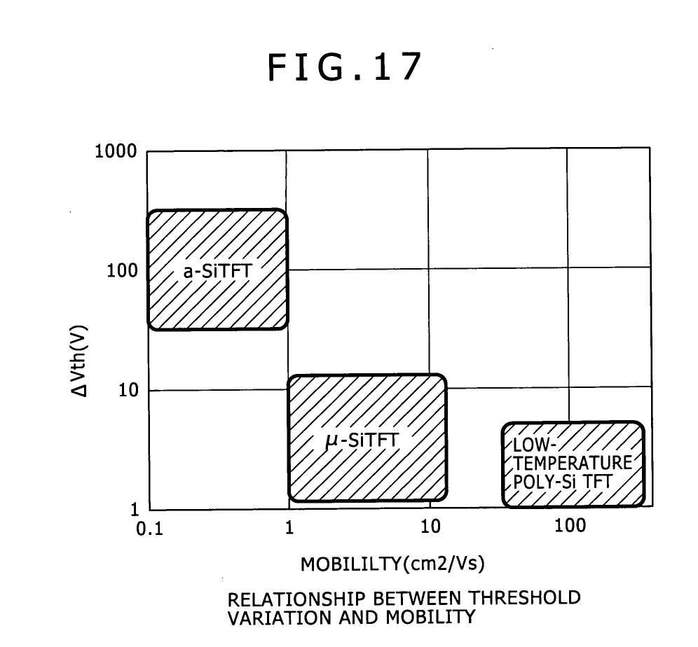

FIG. 18 is an explanatory diagram of luminance unevenness arising because of annealing by plural heads.

### DETAILED DESCRIPTION OF THE PREFERRED EMBODIMENTS

Embodiments of the present invention will be described below in the following order.

### [1. Display Device and Configuration of Pixel Circuit]

### [2. Pixel Circuit Operation]

### [3. Configuration of Write Scanner and Pulse Setting]

### [4. Pulse Width Setting as First Embodiment]

### [5. Pulse Voltage Level Setting as Second Embodiment]

### [6. Modification Examples]

### [1. Display Device and Configuration of Pixel Circuit]

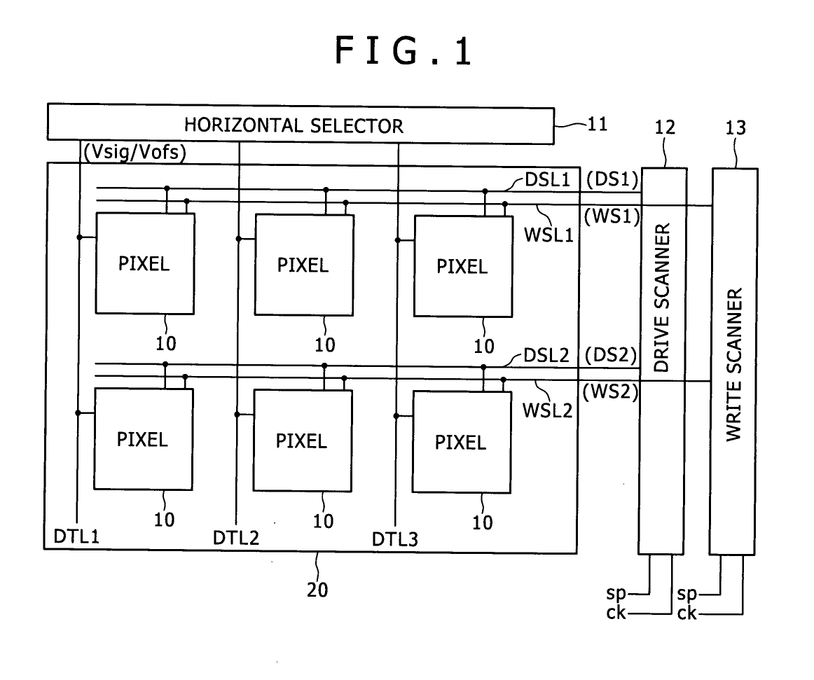

FIG. 1 shows the configuration of an organic EL display device according to an embodiment of the present invention.

This organic EL display device employs organic EL elements as its light emitting elements and includes pixel circuits 10 that carry out light emission driving based on the active-matrix system.

As shown in the diagram, the organic EL display device has a pixel array 20 in which a large number of pixel circuits 10 are arranged in a matrix along the column direction and the row direction (on m rows×n columns). Each of the pixel circuits 10 serves as a light emission pixel of any of red (R), green (G), and blue (B), and a color display device is formed through arrangement of the pixel circuits 10 of the respective colors in a predetermined order.

The organic EL display device includes a horizontal selector 11, a drive scanner 12, and a write scanner 13 as the configuration for the light emission driving of each pixel circuit 10.

Furthermore, signal lines DTL1, DTL2, that are selected by the horizontal selector 11 and supply the voltage dependent on the signal value (grayscale value) of a luminance signal as display data to the pixel circuits 10 are disposed on the pixel array along the column direction. The number of signal lines DTL1, DTL2, . . . is the same as the number of columns of the pixel circuits 10 arranged in a matrix in the pixel array 20.

In addition, on the pixel array 20, write control lines WSL1, WSL2, . . . and power supply control lines DSL1, DSL2, . . . are disposed along the row direction. Each of the number of write control lines WSL and the number of power supply control lines DSL is the same as the number of rows of the pixel circuits 10 arranged in a matrix in the pixel array 20.

The write control lines WSL (WSL1, WSL2, . . . ) are driven by the write scanner 13.

The write scanner 13 sequentially supplies scan pulses WS (WS1, WS2, . . . ) to the write control lines WSL1, WSL2, . . . disposed on the rows at set predetermined timings to thereby line-sequentially scan the pixel circuits 10 on a row-by-row basis.

The power supply control lines DSL (DSL1, DSL2, . . . ) are driven by the drive scanner 12. The drive scanner 12 supplies power supply pulses DS (DS1, DS2, . . . ) to the power supply control lines DSL1, DSL2, . . . disposed on the rows in matching with the line-sequential scanning by the write scanner 13. As the power supply pulses DS (DS1, DS2, . . . ), a supply voltage switched between two values, a drive potential (Vcc) and an initial potential (Vss), is employed.

The drive scanner 12 and the write scanner 13 set the timings of the scan pulses WS and the power supply pulses DS based on a clock ck and a start pulse sp.

The horizontal selector 11 supplies a signal value potential (Vsig) and a reference value potential (Vofs) as an input signal for the pixel circuit 10 to the signal lines DTL1, DTL2, . . . disposed along the column direction in matching with the line-sequential scanning by the write scanner 13.

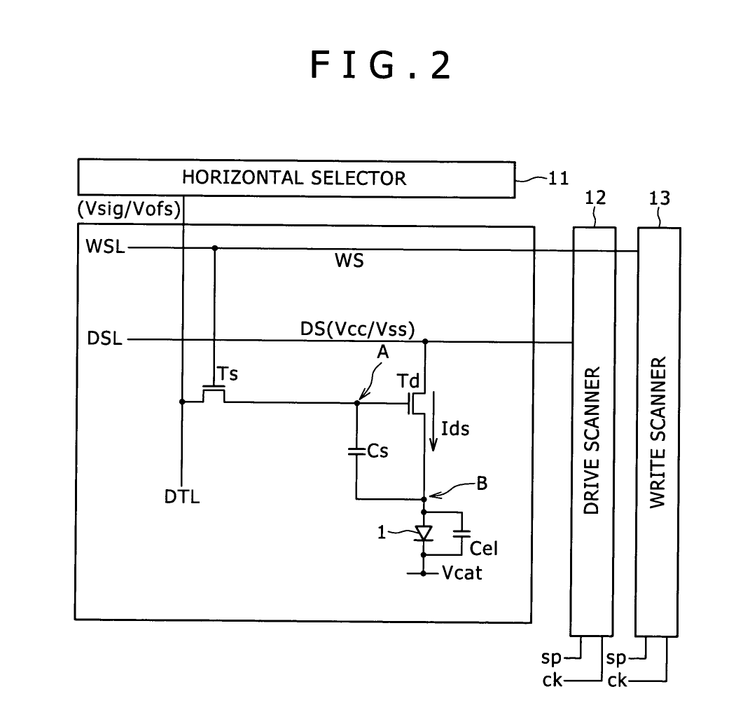

FIG. 2 shows a configuration example of the pixel circuit 10. This pixel circuit 10 is disposed in a matrix manner like the pixel circuits 10 in the configuration of FIG. 1.

For simplification, FIG. 2 shows only one pixel circuit 10 disposed at the intersection of the signal line DTL, the write control line WSL, and the power supply control line DSL.

This pixel circuit 10 includes an organic EL element 1 serving as a light emitting element, one hold capacitor Cs, and n-channel thin film transistors (TFTs) serving as a sampling transistor Ts and a drive transistor Td.

One terminal of the hold capacitor Cs is connected to the source of the drive transistor Td, and the other terminal thereof is connected to the gate of the drive transistor Td.

The light emitting element in the pixel circuit 10 is the organic EL element 1 having e.g. a diode structure, and includes an anode and a cathode. The anode of the organic EL element 1 is connected to the source of the drive transistor Td, and the cathode thereof is connected to a predetermined interconnect (cathode potential Vcat).

A capacitor Cel indicates the parasitic capacitor of the organic EL element 1.

One of the drain and source of the sampling transistor Ts is connected to the signal line DTL, and the other thereof is connected to the gate of the drive transistor Td.

The gate of the sampling transistor Ts is connected to the write control line WSL.

The drain of the drive transistor Td is connected to the power supply control line DSL, and the source thereof is connected to the anode of the organic EL element 1.

The gate node of the drive transistor Td will be represented as the “node A,” and the source node thereof will be represented as the “node B.”

The light emission driving of the organic EL element 1 is carried out in the following manner basically.

At the timing of the application of the signal potential Vsig to the signal line DTL, the sampling transistor Ts is turned on by the scan pulse WS given from the write scanner 13 via the write control line WSL. Thereby, the input signal Vsig from the signal line DTL is written to the hold capacitor Cs.

By current supply from the power supply control line DSL to which the drive potential Vcc is given by the drive scanner 12, the drive transistor Td makes a current Ids dependent on the signal potential held by the hold capacitor Cs flow to the organic EL element 1 to thereby make the organic EL element 1 emit light.

That is, in each frame period, operation of writing the signal value (grayscale value) Vsig to the hold capacitor Cs is carried out in the pixel circuit 10. Thereby, the gate-source voltage Vgs of the drive transistor Td is decided depending on the grayscale to be displayed.

The drive transistor Td operates in the saturation region to thereby function as a constant current source for the organic EL element 1. Specifically, the drive transistor Td serves as a constant current source having the value represented by the following Equation 1.

Ids=(1/2)·μ·(W/L)·Cox·(Vgs−Vth)² (Equation 1)

In this equation, Ids denotes the current flowing between the drain and source of the transistor that operates in the saturation region. μ denotes the mobility. W denotes the channel width. L denotes the channel length. Cox denotes the gate capacitance. Vth denotes the threshold voltage of the drive transistor Td.

As is apparent from Equation 1, the drain current Ids of the transistor is controlled based on the gate-source voltage Vgs in the saturation region. Because the gate-source voltage Vgs is kept constant, the drive transistor Td operates as a constant current source and can make the organic EL element 1 emit light with constant luminance.

This allows the organic EL element 1 to emit light with the luminance dependent on the grayscale value.

### [2. Pixel Circuit Operation]

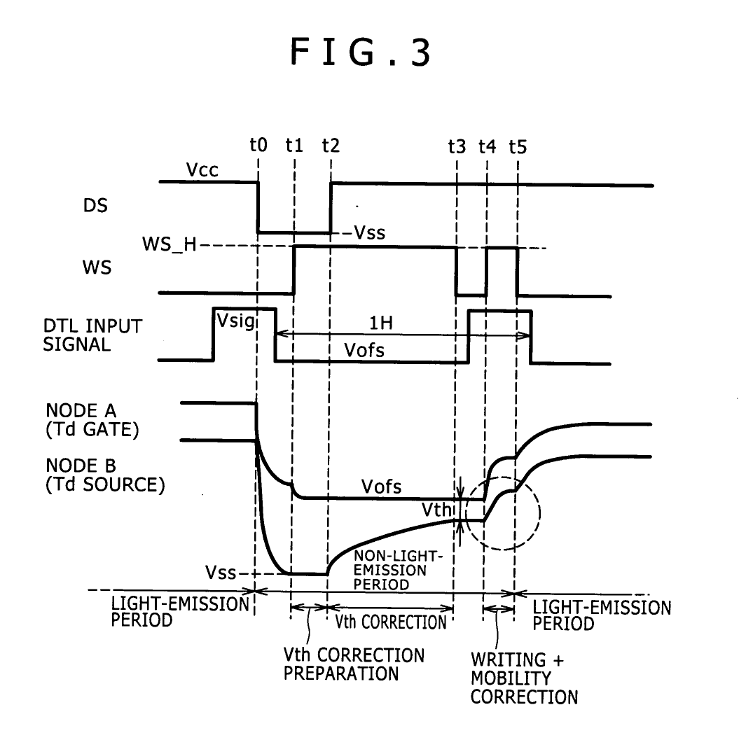

FIG. 3 shows operation waveforms of the pixel circuit 10.

In FIG. 3, the power supply pulse DS supplied from the drive scanner 12 via the power supply control line DSL is shown. As the power supply pulse DS, the drive voltage Vcc or the initial voltage Vss is given.

Furthermore, the scan pulse WS given to the gate of the sampling transistor Ts via the write control line WSL by the write scanner 13 is shown.

In addition, the potential given to the signal line DTL by the horizontal selector 11 is shown as a DTL input signal. This potential has binary values, the signal value Vsig and the reference value Vofs.

Moreover, as node A (Td gate) and node B (Td source), changes in the gate potential and source potential of the drive transistor Td are shown.

Until a timing t0 in FIG. 3, the light emission of the previous frame is carried out. In this light-emission state, the drive voltage Vcc is supplied to the power supply control line DSL as the power supply pulse DS. The sampling transistor Ts is in the off-state. At this time, because the drive transistor Td is so set as to operate in the saturation region, the current Ids flowing to the organic EL element 1 takes the value represented by the above-described Equation 1 depending on the gate-source voltage Vgs of the drive transistor Td.

From the timing t0 in FIG. 3, operation of one cycle for light emission of the present frame is carried out.

This one cycle is carried out during the period until the timing equivalent to the timing t0 of the next frame.

At the timing t0, the drive scanner 12 switches the voltage of the power supply control line DSL to the initial voltage Vss.

The initial voltage Vss is set lower than the sum of the threshold voltage Vthel of the organic EL element 1 and the cathode voltage Vcat thereof. That is, the relationship Vss<Vthel+Vcat is satisfied.

Thereby, the organic EL element 1 stops the light emission, and a current flows toward the power supply control line DSL, so that the anode of the organic EL element 1 is charged to the initial voltage Vss. That is, the source potential (node B) of the drive transistor Td is lowered to the initial voltage Vss as shown in FIG. 3.

In the period from a timing t1 to a timing t2, preparation for threshold correction operation is carried out. Specifically, while the relationship the signal value DTL=the reference value Vofs is kept, the scan pulse WS is switched to the H level to turn on the sampling transistor Ts.

Thereby, the gate potential (node A) of the drive transistor Td is set to the potential of the reference value Vofs.

At this time, the power supply control line DSL is still at the initial potential Vss, and therefore the gate-source voltage of the drive transistor Td takes a value of Vofs−Vss.

Setting the difference between the gate potential and source potential of the drive transistor Td sufficiently larger than the threshold voltage Vth of the drive transistor Td in this manner serves as the preparation for the threshold correction operation. Therefore, the reference value Vofs and the initial voltage Vss should be so set that the relationship Vofs−Vss>Vth is satisfied.

The threshold correction operation is carried out in the period from the timing t2 to a timing t3.

In this case, the power supply pulse DS for the power supply control line DSL is set to the drive voltage Vcc. Thereby, a current flows from the power supply control line DSL toward the anode of the organic EL element 1.

In this case, as long as the leakage current of the organic EL element 1 is considerably smaller than the current that flows through the drive transistor Td, the current of the drive transistor Td is used to charge the hold capacitor Cs and the capacitor Cel. Specifically, as long as the anode potential Vel of the organic EL element 1 satisfies the relationship Vel≦Vcat+Vthel, the current is used to charge the hold capacitor Cs and the capacitor Cel.

At this time, the potential of the node B (the source potential of the drive transistor Td) rises over time as shown in FIG. 3. After the elapse of a certain time, the gate-source voltage of the drive transistor Td takes a value of Vth. At this time, the relationship Vel=Vofs−Vth≦Vcat+Vthel holds.

Thereafter, at the timing t3, the scan pulse WS is switched to the L level and the sampling transistor Ts is turned off, so that the threshold correction operation is completed.

In the period from a timing t4 to a timing t5, writing of the signal value and mobility correction are carried out.

Specifically, after the signal line potential is set to Vsig, the scan pulse WS is switched to the H level and the sampling transistor Ts is turned on at the timing t4, to thereby input the signal value Vsig to the gate of the drive transistor Td.

The signal value Vsig is the voltage dependent on the grayscale. The gate potential of the drive transistor Td becomes the potential of the signal value Vsig because the sampling transistor Ts is turned on. In addition, a current flows because the power supply control line DSL is at the drive voltage Vcc, so that the source potential rises over time.

At this time, unless the source potential of the drive transistor Td surpasses the sum of the threshold voltage Vthel of the organic EL element 1 and the cathode voltage Vcat thereof, the current of the drive transistor Td is used to charge the hold capacitor Cs and the capacitor Cel. That is, this is ensured on condition that the leakage current of the organic EL element 1 is considerably smaller than the current that flows through the drive transistor Td.

Furthermore, at this time, the current flowing through the drive transistor Td reflects the mobility p because the threshold correction operation for the drive transistor Td has been completed.

Specifically, for the drive transistor Td having high mobility, the amount of current at this time is large and the rise of the source potential is also fast. In contrast, for the drive transistor Td having low mobility, the amount of current is small and the rise of the source potential is slow.

Because of this source potential rise, the gate-source voltage of the drive transistor Td decreases in such a manner as to reflect the mobility thereof, and becomes Vgs that completely corrects the mobility after the elapse of a certain time.

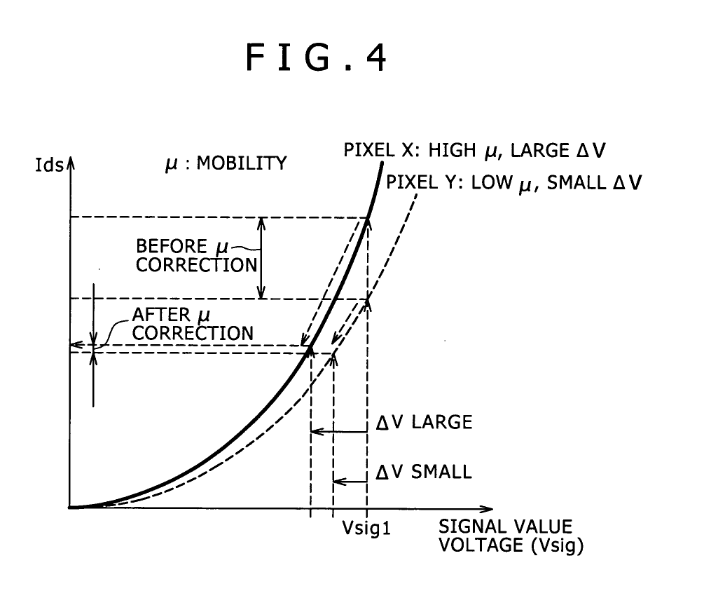

FIG. 4 shows the principle of the mobility correction. In FIG. 4, the voltage as the signal value is plotted on the abscissa, and the current Ids flowing to the organic EL element 1 is plotted on the ordinate. The full line indicates the characteristic of a pixel circuit X involving high mobility μ, and the dashed line indicates the characteristic of a pixel circuit Y involving low mobility μ.

When a certain signal value Vsig1 is given, the voltage rise ΔV of the node B is larger in the pixel circuit involving higher mobility. That is, although the difference in the amount of current between the pixel circuits X and Y is large before the correction, the difference in the amount of current becomes small after the mobility correction because of the difference in the voltage rise ΔV. This makes it possible to correct luminance variation due to the difference in the mobility among the respective pixel circuits 10.

In this manner, the writing of the signal value Vsig to the hold capacitor Cs and the mobility correction are carried out.

At the timing t5 in FIG. 3, the scan pulse WS falls down to turn off the sampling transistor Ts, so that the signal value writing is ended and the organic EL element 1 is made to emit light.

The drive transistor Td allows the flowing of the current Ids dependent on the gate-source voltage as shown by the above-described Equation 1. Because the gate-source voltage Vgs of the drive transistor Td is constant, the drive transistor Td makes the constant current Ids flow to the organic EL element 1. Furthermore, the potential of the node B rises to such a voltage that the current Ids flows to the organic EL element 1, and thereby the organic EL element 1 emits light.

Thereafter, the light emission is continued until the start of the next light-emission cycle (the timing t0 of the next frame).

In such operation, the I-V characteristic of the organic EL element 1 changes if the total light-emission time thereof becomes long. Therefore, the potential of the node B in the diagram also changes.

However, the current that flows to the organic EL element 1 does not change because the gate-source voltage Vgs of the drive transistor Td is kept at a constant value. Consequently, even when the I-V characteristic of the organic EL element 1 deteriorates, a constant current continues to typically flow, and the luminance of the EL element does not change.

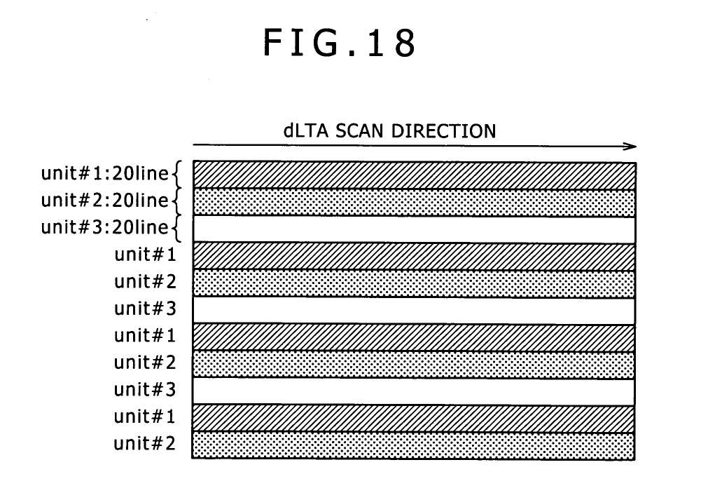

For the pixel array 20 of the present example, the annealing treatment (raster laser scan) with use of plural laser heads (high-power-output semiconductor laser) is performed as described above with FIG. 18 as one of process techniques for the μ-Si TFTs in the pixel array 20.

Then variation in the mobility of the drive transistor Td arises in units of the line group (unit) for which the same laser head is used, and thus luminance variation like that shown in FIG. 18 occurs.

For the variation in the mobility of the TFT serving as the drive transistor Td in the pixel circuit 10, mobility correction on a pixel-by-pixel basis can be carried out by the above-described mobility correction at the time of the writing of the signal value for the light emission of the pixel circuit 10. However, in this mobility correction, excessive extension of the correction time (the period from the timing t4 to the timing t5) often causes the inversion of unevenness because of an excess degree of the correction.

Moreover, if there are plural boundaries of the difference in the mobility variation on a unit-by-unit basis like that in FIG. 18, the range of the correction completion time for eliminating the unevenness differs.

Then, if the correction period is decided with the scan pulse WS having the same waveform for the entire panel, the unevenness across the boundary of the units disappears in some places, whereas the unevenness is inverted in other places.

Therefore, regarding the mobility variation on a unit-by-unit basis attributed to the laser annealing like that in FIG. 18, the mobility correction in the above-described light-emission operation cycle does not properly work in some cases.

To address this problem, the pulse waveform of the scan pulse is set depending on the mobility on a unit-by-unit basis in embodiments of the present invention.

### [3. Configuration of Write Scanner and Pulse Setting]

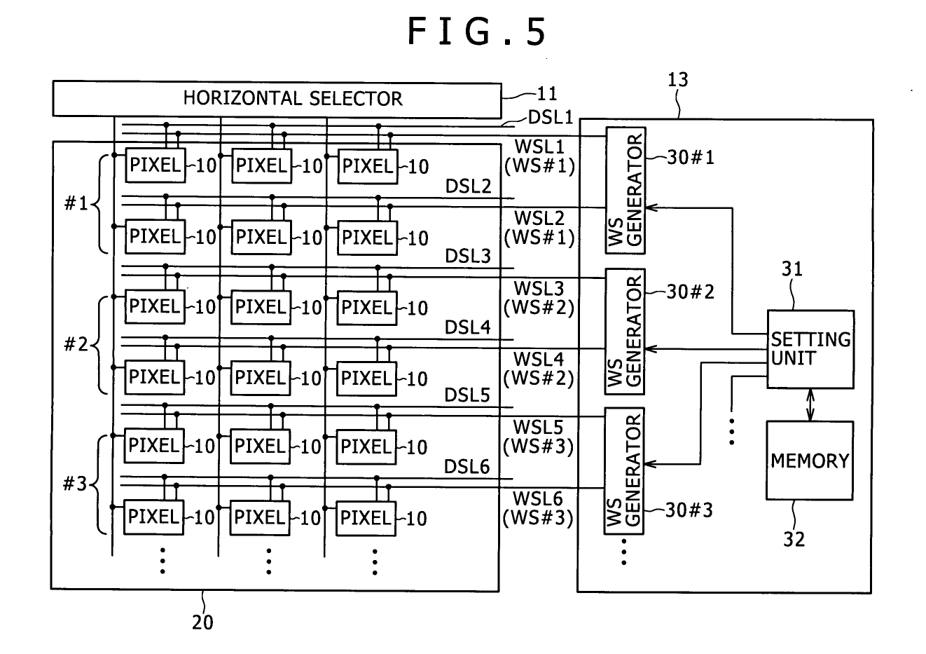

Details of the write scanner 13 will be described below with FIG. 5. In FIG. 5, diagrammatic representation of the drive scanner 12 is omitted.

The laser annealing by plural heads in the manufacturing process for the pixel array 20 is performed in such a way that 20 lines are regarded as one unit (unit of the plural lines annealed by the same laser head) for example.

Hereinafter, the description will be made based on the assumption that two lines are regarded as one unit for simplification of the description and the diagrammatic representation.

Specifically, pixel lines on six rows are shown in FIG. 5. The pixel lines as the first line and the second line are defined as lines of a unit #1. The pixel lines as the third line and the fourth line are defined as lines of a unit #2. The pixel lines as the fifth line and the sixth line are defined as lines of a unit #3.

That is, in the example shown in FIG. 5, the laser annealing is performed by three laser heads. Specifically, the laser annealing of the lines of the unit #1, the lines of the unit #2, and the lines of the unit #3 is performed by a first laser head, a second laser head, and a third laser head, respectively.

The write scanner 13 outputs the scan pulses WS to the write control lines WSL (WSL1, WSL2, WSL3, . . . ) as described above to thereby carry out conduction control of the sampling transistors Ts in the pixel circuits 10 of the respective lines.

In this write scanner 13, as WS generators 30 that generate the scan pulses WS, WS generators 30#1, 30#2, and 30#3 corresponding to the units #1, #2, and #3, respectively, are provided.

Each of the WS generators 30#1, 30#2, and 30#3 includes a shift register, a pulse width varying unit, a pulse voltage varying unit, and so on, and outputs the scan pulse WS shaped into a predetermined waveform to the corresponding write control line WSL at a predetermined timing.

The WS generator 30#1 corresponding to the lines of the unit #1 outputs a scan pulse WS#1 having the waveform decided corresponding to the pixel circuits 10 on the lines of the unit #1.

The WS generator 30#2 corresponding to the lines of the unit #2 outputs a scan pulse WS#2 having the waveform decided corresponding to the pixel circuits 10 on the lines of the unit #2.

The WS generator 30#3 corresponding to the lines of the unit #3 outputs a scan pulse WS#3 having the waveform decided corresponding to the pixel circuits 10 on the lines of the unit #3.

The scan pulses WS#1, WS#2, and WS#3 are each shaped into the waveform obtained by setting the pulse width or the pulse voltage level depending on the mobility of the drive transistors Td in the pixel circuits 10 of the corresponding unit as described later.

For this purpose, a setting unit 31 that specifies the pulse waveform is provided for the WS generators 30#1, 30#2, and 30#3. The setting unit 31 specifies the pulse widths or the pulse voltage levels as the scan pulses WS#l, WS#2, and WS#3 for the WS generators 30#l, 30#2, and 30#3, respectively.

In a memory 32, setting values of the pulse width or the pulse voltage level as the scan pulses WS#1, WS#2, and WS#3 are stored.

The setting unit checks the pulse widths or pulse voltage levels that should be set from a table in the memory 32 responding to the measured values of the mobility of the drive transistors Td for the units #1, #2, and #3, and controls the WS generators 30#1, 30#2, and 30#3 in accordance with the values of the pulse widths or the pulse voltage levels.

The setting values as the pulse widths or the pulse voltage levels for the WS generators 30#1, 30#2, and 30#3 are written to the memory 32 before factory shipment for example.

Specifically, at the timing when the display panel is manufactured, mobility of each unit is measured, and the mobility and the setting value of the proper pulse waveform suitable for the mobility are calculated. Furthermore, the setting value is stored in the memory 32.

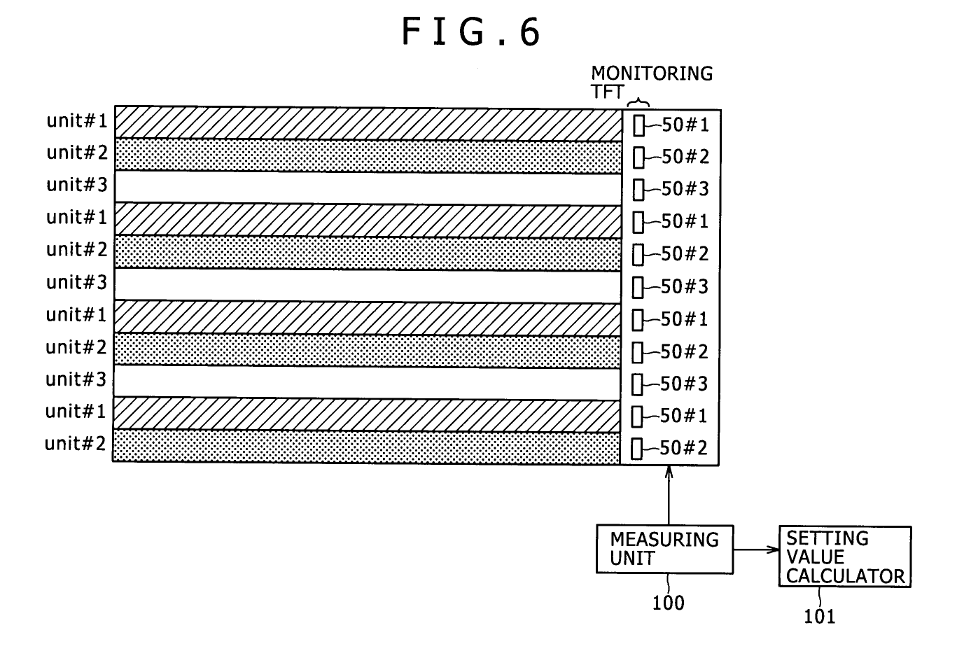

One example of this scheme is shown in FIG. 6.

In FIG. 6, the respective lines of the pixel array 20 are schematically shown on a unit-by-unit basis. At one end side of the pixel array 20, monitoring TFTs 50 (50#1, 50#2, 50#3) are disposed.

That is, the monitoring TFTs 50 are also fabricated together with the respective pixel circuits 10 in the manufacturing process for the pixel array 20.

The monitoring TFT 50#1 is formed in the laser annealing range of the unit #1. The monitoring TFT 50#2 is formed in the laser annealing range of the unit #2. The monitoring TFT 50#3 is formed in the laser annealing range of the unit #3.

With use of the monitoring TFTs 50, the mobility of the TFTs in each unit is measured by a measuring unit 100.

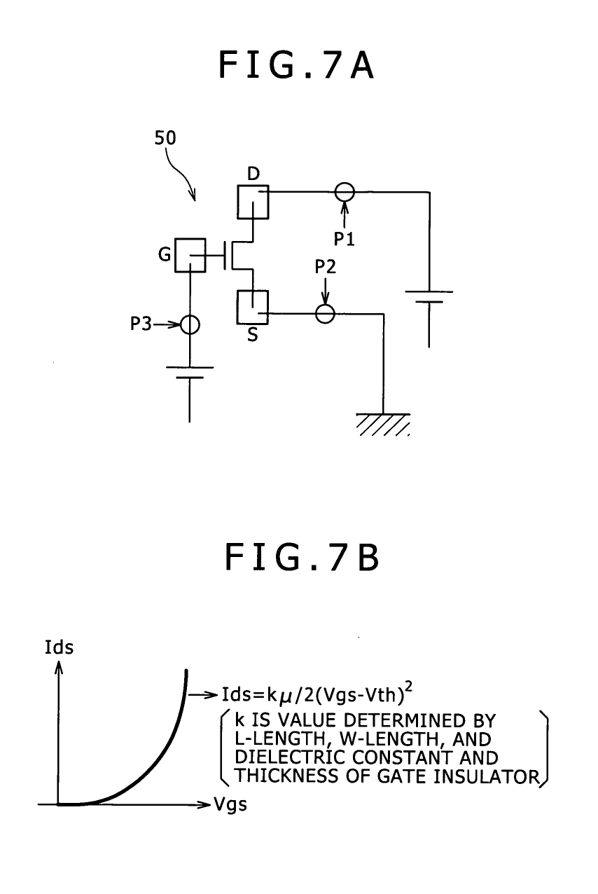

The measurement method is shown in FIG. 7A. The system configuration is so designed that detecting pins P1, P2, and P3 of the measuring unit 100 can be set for the drain, source, and gate of the monitoring TFT 50. The I-V characteristic of the monitoring TFT 50 is measured by using the measuring unit 100, and the mobility is calculated from the measured characteristic.

FIG. 7B shows the characteristic of the gate-source voltage Vgs and the drain-source current Ids of a TFT. The mobility μ can be obtained by giving a predetermined gate-source voltage Vgs and measuring the current Ids.

Specifically, the mobility μ is derived from the measured I-V characteristic of the TFT by using the following Shockley equation.

Ids=kμ/2 (Vgs−Vth)² (k is a value determined by the L-length, the W-length, and the dielectric constant and thickness of the gate insulator)

As shown in FIG. 6, the measurement is performed about the monitoring TFTs 50#1, 50#2, and 50#3 for each unit, and the mobility is measured for the respective units #1, #2, and #3.

In this case, if the monitoring TFT 50 is formed for each line, a large number of monitoring TFTs 50#1 exist for the unit #1 for example. However, only one monitoring TFT 50#1 may be used. Alternatively, the average of the large number of monitoring TFTs 50#1 or the like may be used.

When the mobility values μ (μ#1, μ#2, μ#3) of the respective units #1, #2, and #3 are measured, a setting value calculator 101 calculates setting values of the pulse width or the pulse voltage level as the scan pulses WS#1, WS#2, and WS#3 from the respective mobility values. The setting values are stored in the memory 32.

The measuring unit 100 may be a general-purpose detecting device as a separate unit. The setting value calculator 101 may be an arithmetic processing device such as a personal computer, or may be a dedicated device for the display device of the present example. Alternatively, the configuration serving as the measuring unit 100 and the setting value calculator 101 may be incorporated inside the display device so that the mobility measurement for the respective units #1, #2, and #3, the setting value calculation, and setting value writing to the memory 32 can be carried out at any timing.

Furthermore, table data of setting values corresponding to the respective values of the mobility may be stored in the memory 32 in advance.

In addition, the measured mobility μ of each unit is written to the memory 32.

The setting unit 31 reads out the mobility μ#1, μ#2, and μ#3 of the respective units #1, #2, and #3 written to the memory 32 through the measurement and refers to the table data in the memory 32 to decide the setting values corresponding to the mobility μ#1, μ#2, and μ#3. Moreover, the setting unit 31 may instruct the WS generators 30#1, 30#2, and 30#3 to form pulse waveforms based on the decided setting values.

### [4. Pulse Width Setting as First Embodiment]

As described above, the write scanner 13 sets the pulse waveform of the scan pulse WS on a unit-by-unit basis and outputs the scan pulses WS to the respective units. An example in which the pulse width (the conduction period of the sampling transistor Ts) is set based on the mobility measurement for each unit as the setting of the pulse waveform will be described below as a first embodiment of the present invention.

In the present example, the pulse width of the scan pulse WS is set depending on the mobility of the corresponding unit, and the time of the writing in the pixel circuit 10 is varied on a unit-by-unit basis. Thereby, the amount of rise of the potential of the node B in FIG. 2, i.e. the amount of mobility correction, is adjusted to reduce luminance variation among the units.

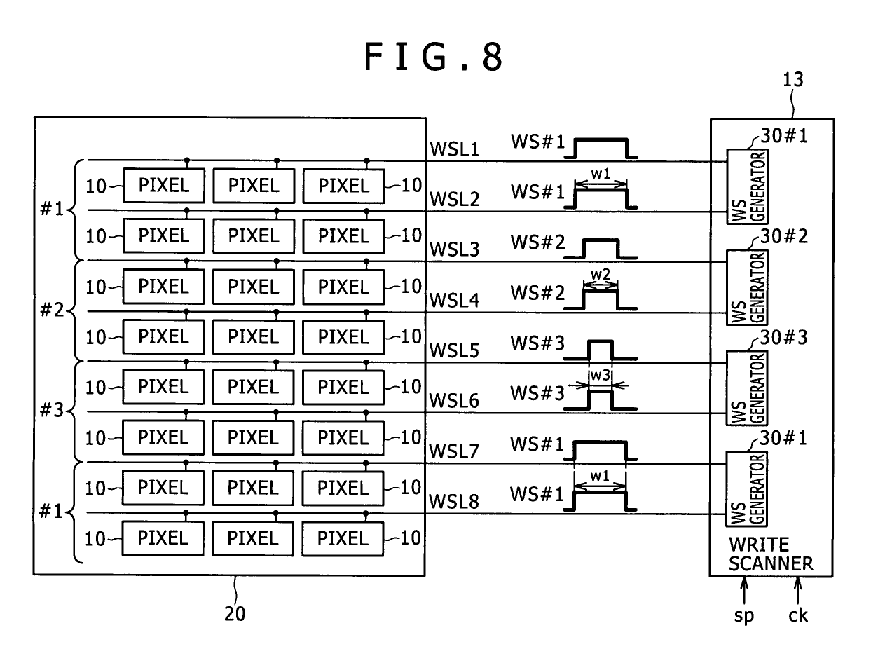

FIG. 8 shows an example of the scan pulses WS.

In the following example, the unit #1 is a unit in which the drive transistor Td has low mobility. The unit #2 is a unit in which the drive transistor Td has intermediate mobility. The unit #3 is a unit in which the drive transistor Td has high mobility.

As described above, the WS generators 30#1, 30#2, and 30#3 are formed corresponding to the respective units #1, #2, and #3 in the write scanner 13, and each output the scan pulse WS having the pulse width suitable for the corresponding unit.

The WS generator 30#1 outputs the scan pulse WS#1 having the largest pulse width w1 to the write control lines WSL1 and WSL2 (WSL7 and WSL8) for the unit #1 including the drive transistors Td having low mobility.

The WS generator 30#2 outputs the scan pulse WS#2 having an intermediate pulse width w2 to the write control lines WSL3 and WSL4 for the unit #2 including the drive transistors Td having intermediate mobility.

The WS generator 30#3 outputs the scan pulse WS#3 having the smallest pulse width w3 to the write control lines WSL5 and WSL6 for the unit #3 including the drive transistors Td having high mobility.

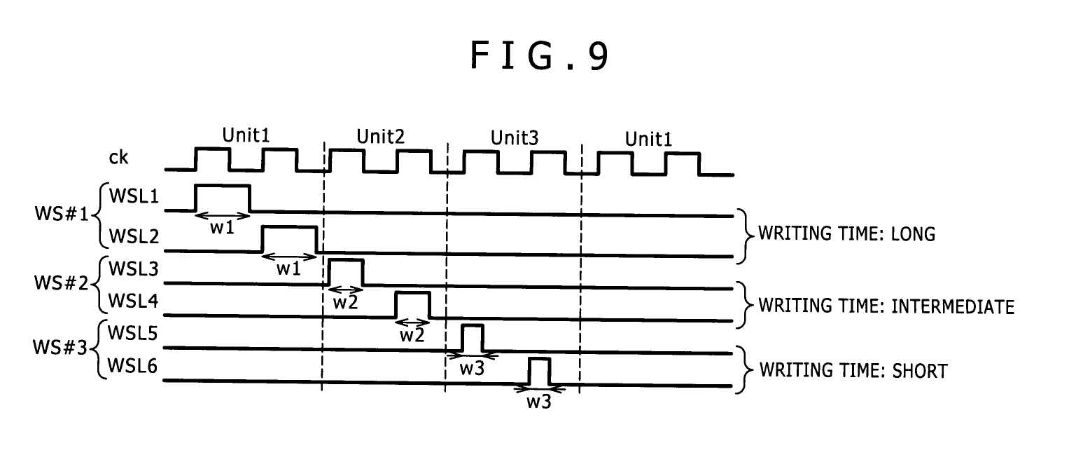

FIG. 9 shows the scan waveforms of the respective lines by the respective scan pulses WS. The clock ck is the horizontal synchronizing clock.

The write scanner 13 sequentially gives the scan pulses WS to the pixel circuits 10 on the respective lines as shown in the diagram. Specifically, the write scanner 13 outputs the scan pulses WS (WS#1, WS#2, WS#3) having the pulse width w1, the pulse width w2, and the pulse width w3 to the lines of the unit #1, the lines of the unit #2, and the lines of the unit #3, respectively.

As shown in FIG. 2, the sampling transistor Ts is an n-channel TFT. Therefore, the period during which the scan pulse WS is at the H level serves as the period of the writing of the signal value Vsig and the mobility correction.

The scan pulses WS (WS#1, WS#2, WS#3) shown in FIG. 9 are each equivalent to the pulse of the period from the timing t4 to the timing t5 in FIG. 3, in which the waveform of one cycle for one pixel circuit 10 is shown. As described above with FIG. 3, the scan pulse WS is set to the H level also during the period from the timing t1 to the timing t3 for the threshold correction. However, diagrammatic representation of the H-level part of the scan pulse WS during this period is omitted in FIG. 9.

In this manner, the write scanner 13 outputs the scan pulses WS whose pulse widths differ from unit to unit. A description will be made below about how this scheme can reduce or eliminate luminance variation attributed to laser annealing by plural heads.

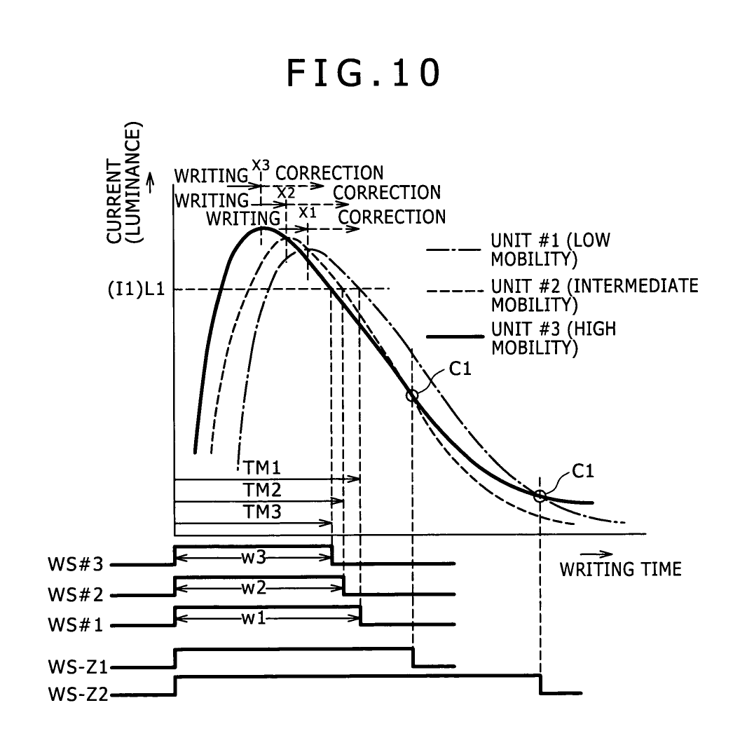

FIG. 10 shows a graph made by plotting the writing time on the abscissa and plotting the current flowing to the organic EL element 1 on the ordinate. In this graph, the characteristics of the respective units #1, #2, and #3 when the same signal value Vsig is given are shown. These characteristics are each equivalent to the characteristic of the period from the timing t4 to the timing t5 in FIG. 3.

The one-dot chain line indicates the characteristic of the unit #1 involving low mobility. The dashed line indicates the characteristic of the unit #2 involving intermediate mobility. The full line indicates the characteristic of the unit #3 involving high mobility.

In the unit #3 involving high mobility, increase in the amount of current at the time of the writing of the signal value Vsig is fast. Therefore, the signal value writing can be completed at a timing X3 in the diagram, and the mobility correction can be carried out after the timing X3. On the other hand, in the units #2 and #1, which involve lower mobility, the timing of the writing completion is later as shown by X2 and X1.

Here, a discussion will be made about the case in which the scan pulses WS having a pulse width common to the respective units are given like the related arts. That is, in this case, the length of the writing and mobility correction period (the period from the timing t4 to the timing t5 in FIG. 3), specified by the pulse width of the scan pulse WS, is the same.

To eliminate luminance variation dependent on the difference in the mobility from unit to unit, the mobility correction is so carried out that the same amount of current is obtained. For example, in the case of attempting to eliminate luminance variation between the units #1 and #2 having the characteristics of FIG. 10, the pulse width is set to that of a scan pulse WS-Z1 shown at the lower part of FIG. 10 because the amounts of current are the same between the units #1 and #2 at a point C1. That is, the mobility correction is carried out in such a way that the timing of the point C1 is defined as the completion point of the mobility correction. However, in this case, the luminance variation may not be eliminated for the unit #3. This is because the amount of current in the unit #3 is not the same as that in the units #1 and #2.

On the other hand, for example, in the case of attempting to eliminate luminance variation between the units #1 and #3, the pulse width is set to that of a scan pulse WS-Z2 because the amounts of current are the same between the units #1 and #3 at a point C2. That is, the mobility correction is carried out in such a way that the timing of the point C2 is defined as the completion point of the mobility correction. However, in this case, the luminance variation may not be eliminated for the unit #2.

That is, the completion point of the mobility correction varies on each unit combination basis, and therefore the mobility correction proper for all of the units is difficult. Moreover, when the mobility correction time is set longer, the amount of current at the time of light emission also decreases, which is disadvantageous for the entire light emission luminance.

To address this problem, in the present embodiment, the pulse width of the scan pulse WS, i.e. the period of the signal value writing and the mobility correction, is set on a unit-by-unit basis as described above. Thereby, proper mobility correction is carried out for each unit, and thus luminance variation among the respective units is eliminated.

For example, suppose that it is desired to obtain light emission luminance L1 (the amount of current I1) in response to a certain signal value Vsig.

In the unit #3, the amount of current becomes I1 at the elapse of a time TM3 from the writing start. Therefore, the pulse width of the scan pulse WS#3 is set to the pulse width w3 equivalent to the time TM3.

In the unit #2, the amount of current becomes I1 at the elapse of a time TM2 from the writing start. Therefore, the pulse width of the scan pulse WS#2 is set to the pulse width w2 equivalent to the time TM2.

In the unit #1, the amount of current becomes I1 at the elapse of a time TM1 from the writing start. Therefore, the pulse width of the scan pulse WS#1 is set to the pulse width w1 equivalent to the time TM1.

Then, in all of the units, the amount of current flowing to the organic EL element 1 is I1 and light emission with the luminance L1 can be achieved in response to the certain signal value Vsig.

That is, by adjusting the period of the signal value writing and the mobility correction on a unit-by-unit basis, the difference in the mobility from unit to unit can be eliminated and light emission with uniform luminance can be carried out.

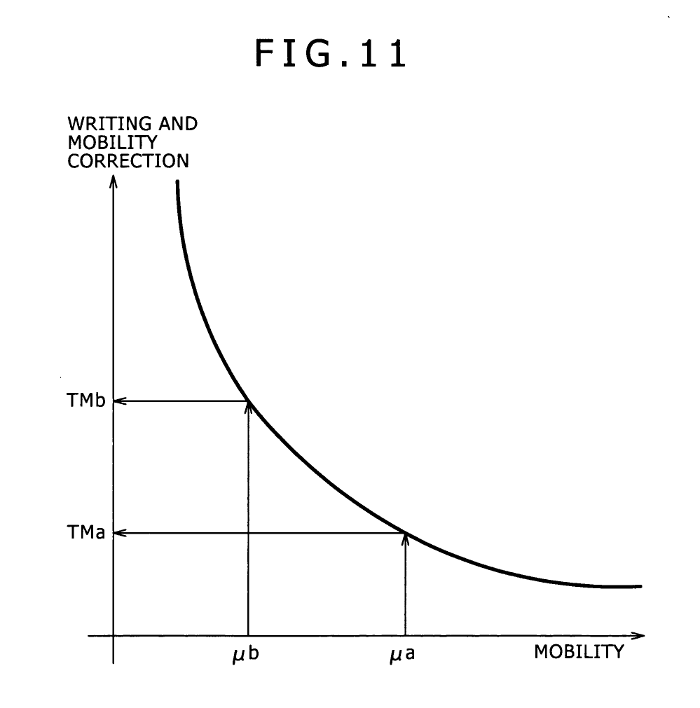

FIG. 11 shows a curve that is made by plotting the mobility on the abscissa and plotting the time of the writing and the mobility correction on the ordinate and indicates such a relationship between the mobility and the time of the writing and the mobility correction that the luminance (the amount of current of the organic EL element 1) is constant.

Specifically, this curve indicates that the constant light emission luminance can be achieved if the times of the writing and the mobility correction are set to TMa and TMb in response to different mobility values μa and μb, respectively. Based on such a relationship, the pulse widths of the scan pulses WS#1, WS#2, and WS#3 (=the times of the writing and the mobility correction) for the above-described respective units #1, #2, and #3 can be set.

As is apparent from the above description, in the present example, the write scanner 13 sets the pulse widths of the scan pulses WS (the pulse width from the timing t4 to the timing t5 in FIG. 3) for the respective units #1, #2, and #3 depending on the measured values of the mobility of the units #1, #2, and #3. This pulse width setting is so made that the relationship in FIG. 11 is kept.

Then video output free from luminance difference is permitted even when variation in the mobility from unit to unit exists attributed to laser annealing treatment by plural laser heads.

### [5. Pulse Voltage Level Setting as Second Embodiment]

An example in which the write scanner 13 sets the pulse voltage level based on mobility measurement for each unit will be described below as a second embodiment of the present invention.

In the present example, the pulse voltage level (H-level voltage) of the scan pulse WS is set depending on the mobility of the corresponding unit and the speed of writing of the signal value Vsig to the pixel circuit 10 is varied on a unit-by-unit basis, to thereby reduce luminance variation among the units.

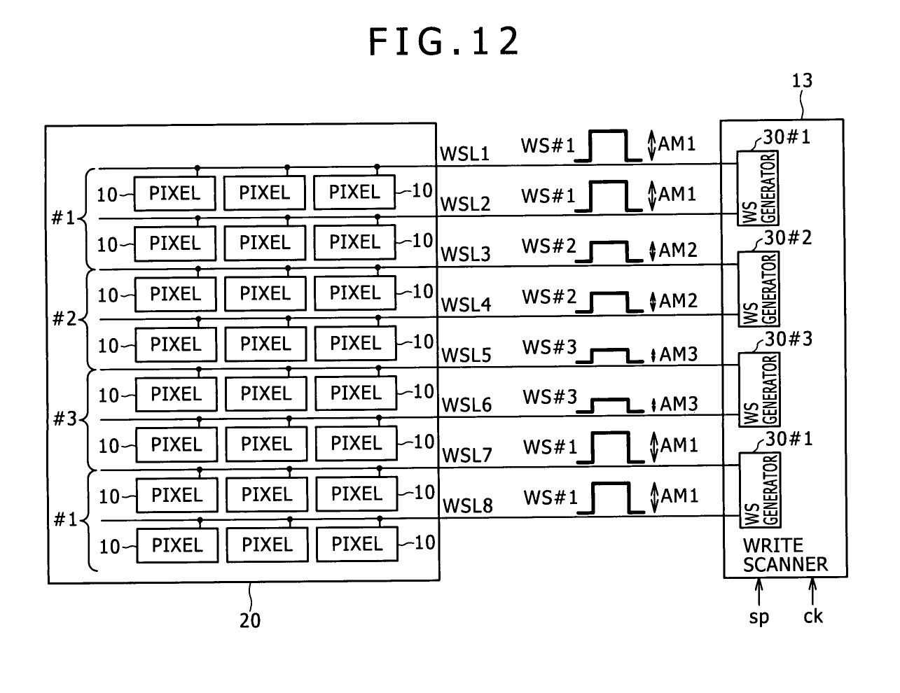

FIG. 12 shows an example of the scan pulses WS.

Also in this case, the unit #1 is a unit in which the drive transistor Td has low mobility. The unit #2 is a unit in which the drive transistor Td has intermediate mobility. The unit #3 is a unit in which the drive transistor Td has high mobility.

The WS generators 30#1, 30#2, and 30#3 in the write scanner 13 output the scan pulses WS whose pulse voltage levels (H-level voltages) are set corresponding to the respective units #1, #2, and #3.

The WS generator 30#1 outputs the scan pulse WS#1 having the highest voltage AM1 to the write control lines WSL1 and WSL2 (WSL7 and WSL8) for the unit #1 including the drive transistors Td having low mobility.

The WS generator 30#2 outputs the scan pulse WS#2 having an intermediate voltage AM2 to the write control lines WSL3 and WSL4 for the unit #2 including the drive transistors Td having intermediate mobility.

The WS generator 30#3 outputs the scan pulse WS#3 having the lowest voltage AM3 to the write control lines WSL5 and WSL6 for the unit #3 including the drive transistors Td having high mobility.

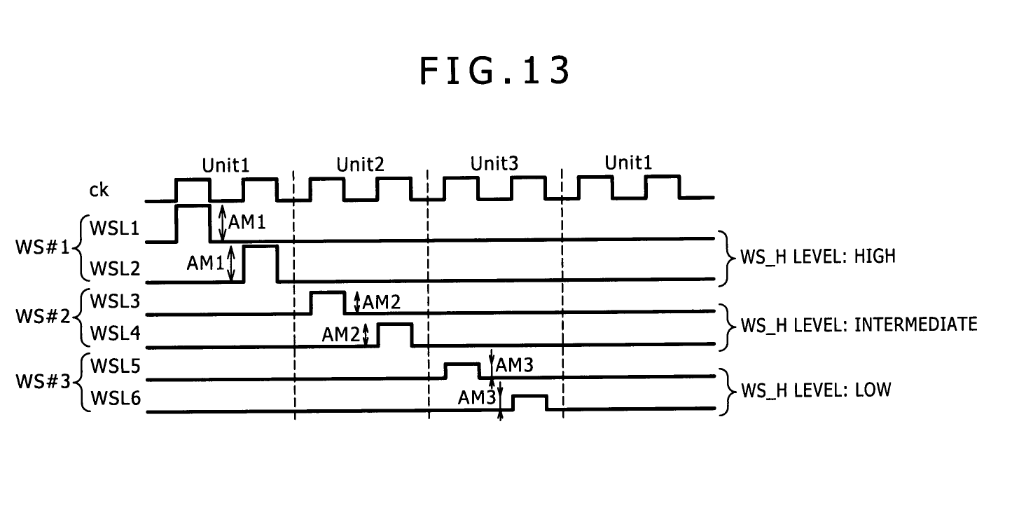

FIG. 13 shows the scan waveforms of the respective lines by the respective scan pulses WS. The clock ck is the horizontal synchronizing clock.

The write scanner 13 sequentially gives the scan pulses WS to the pixel circuits 10 on the respective lines as shown in the diagram. Specifically, the write scanner 13 outputs the scan pulses WS (WS#1, WS#2, WS#3) having the H-level voltage AM1, the H-level voltage AM2, and the H-level voltage AM3 to the lines of the unit #1, the lines of the unit #2, and the lines of the unit #3, respectively.

As described above, the sampling transistor Ts is an n-channel TFT. Therefore, the period during which the scan pulse WS is at the H level serves as the period of the writing of the signal value Vsig and the mobility correction.

Also in this FIG. 13, only the pulse of the period from the timing t4 to the timing t5 in FIG. 3 is shown, whereas diagrammatic representation of the scan pulse WS of the period from the timing t1 to the timing t3 for the threshold correction is omitted.

In this manner, the write scanner 13 outputs the scan pulses WS#1, WS#2, and WS#3 whose H-level voltages differ from unit to unit. A description will be made below about how this scheme can reduce or eliminate luminance variation attributed to laser annealing by plural heads.

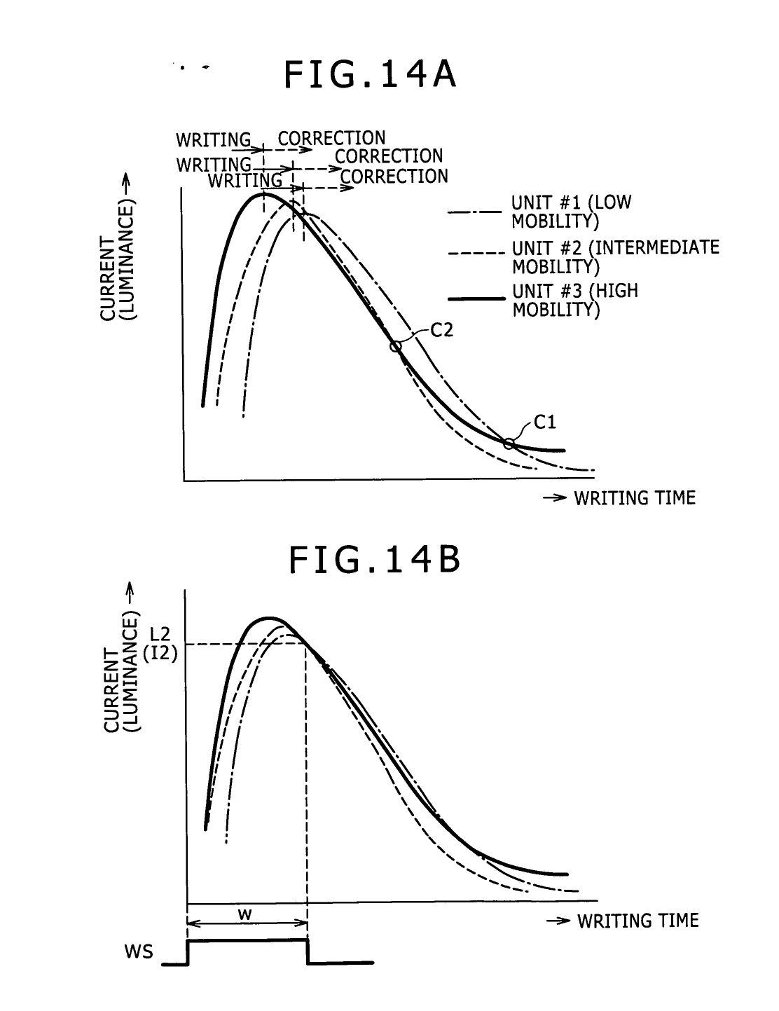

FIG. 14A shows a graph made by plotting the writing time on the abscissa and plotting the current flowing to the organic EL element 1 on the ordinate, similarly to the above-described FIG. 10. In this graph, the characteristics of the respective units #1, #2, and #3 (the characteristic of the period from the timing t4 to the timing t5 in FIG. 3) when the same signal value Vsig is given are shown.

The one-dot chain line indicates the characteristic of the unit #1 involving low mobility. The dashed line indicates the characteristic of the unit #2 involving intermediate mobility. The full line indicates the characteristic of the unit #3 involving high mobility.

As described above, the mobility correction proper for each of the units is difficult if the pulse widths of the scan pulses WS for the respective units #1, #2, and #3 are identical to each other.

In the present example, the scan pulses WS#1, WS#2, and WS#3 that have the same pulse width but have different H-level voltages are given to the respective units #1, #2, and #3.

If the H-level voltage of the scan pulse WS is increased, the following characteristics are observed: the writing speed becomes higher; the peak luminance rises; and the speed of drop of the current after the wiring of the signal value Vsig becomes higher.

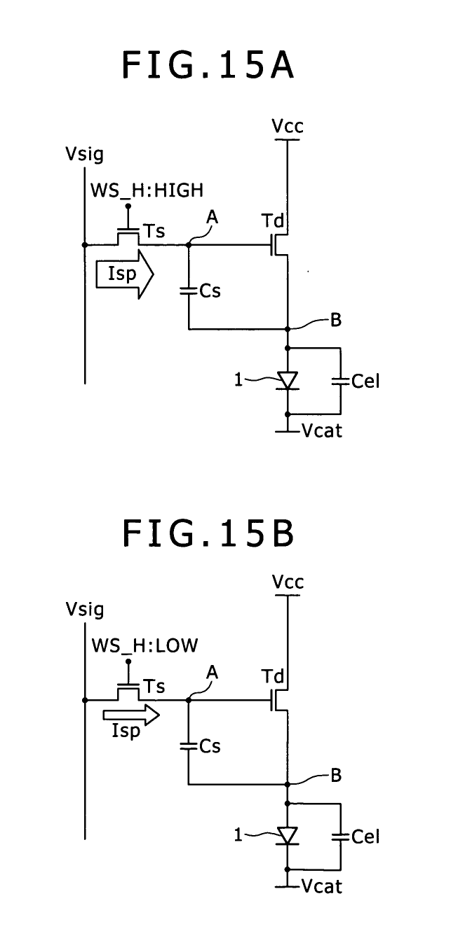

With reference to FIGS. 15A and 15B, the principle of how to increase the writing speed by raising the H-level voltage of the scan pulse WS will be described below.

FIG. 15A shows the case in which the scan pulse WS having a high H-level voltage is given to the gate of the sampling transistor Ts. FIG. 15B shows the case in which the scan pulse WS having a low H-level voltage is given to the gate of the sampling transistor Ts.

The writing time t of the signal value Vsig for the pixel circuit 10 can be represented by the following equation.

t=(ΔV×C)/Isp

In this equation, ΔV denotes the amount of voltage rise of the node A, C denotes the capacitance of the hold capacitor Cs, and Isp denotes the current between the drain and source of the sampling transistor Ts.

The higher the H-level voltage given to the gate of the sampling transistor Ts is, the larger the current Isp of the sampling transistor Ts becomes.

Therefore, when the H-level voltage of the scan pulse WS is higher, the current Isp is larger, and thus it can be understood from the above equation that the writing time t becomes shorter.

The correction completion time can be shortened and adjusted by utilizing the characteristic that the speed of writing of the signal value Vsig to the pixel circuit 10 via the sampling transistor Ts varies depending on the H-level voltage of the scan pulse WS in, this manner.

Specifically, the characteristics of FIG. 14B can be obtained by setting the H-level voltage of the scan pulse WS higher for the unit involving lower mobility.

More specifically, each of the H-level voltages of the scan pulses WS#2 and WS#1 for the units #2 and #1 is raised by the desired level. Thereby, the characteristics arising from the shift of the characteristic curves toward the left side in the diagram are obtained.

Assuming that the pulse width of the scan pulse WS is “w” shown at the lower part of FIG. 14B, the mobility correction completion points of the respective units can be made identical to each other at the point corresponding to the period of this pulse width w.

The pulse width w of the scan pulse WS is equivalent to the period from the timing t4 to the timing t5 in FIG. 3, i.e. the period of the writing and the mobility correction.

In the case of FIG. 14B, the respective units #1, #2, and #3 have the same current 12 (the luminance L2) at the end of the period of this pulse width w, i.e. at the completion timing of the mobility correction.

That is, in all of the units, the amount of current flowing to the organic EL element 1 is I2 and light emission with the luminance L2 can be achieved in response to the certain signal value Vsig.

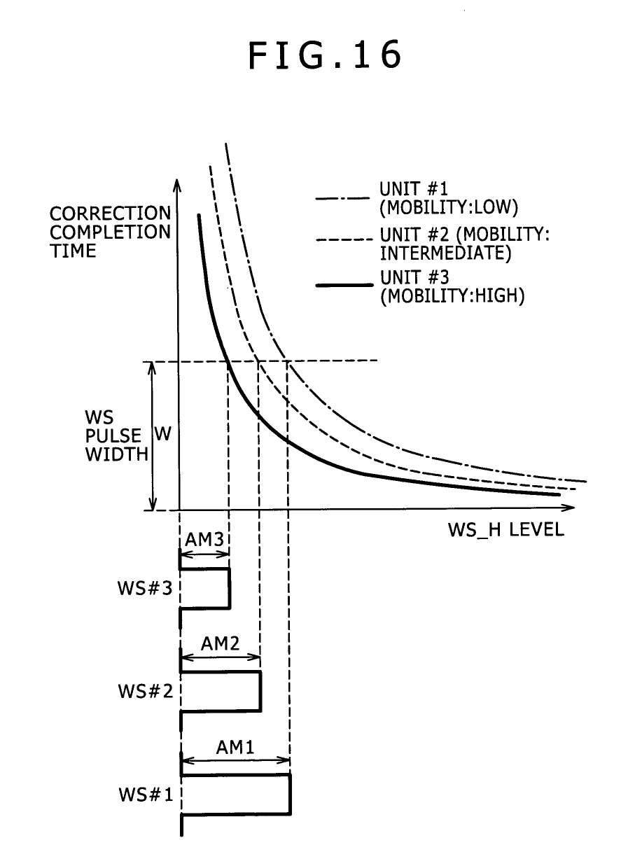

FIG. 16 shows a graph made by plotting the H-level voltage on the abscissa and plotting the correction completion time on the ordinate. Actual measurement about the respective units #1, #2, and #3 will provide characteristic curves like those in the graph.

When it is desired to set the correction completion time to the time indicated by the dashed line (i.e. when it is desired to set the pulse width of the scan pulse WS to w), the H-level voltages of the scan pulses WS#1, WS#2, and WS#3 for the units #1, #2, and #3 are set to AM1, AM2, and AM3, respectively, as shown at the lower part of the diagram.

In the above-described manner, the H-level voltage of the scan pulse WS given during the period of the signal value writing and the mobility correction is adjusted on a unit-by-unit basis. Thereby, the difference in the mobility from unit to unit can be eliminated and light emission with uniform luminance can be carried out.

### [6. Modification Examples]

The embodiments of the present invention have been described above. However, a further diversity of modification examples of the present invention will be possible.

For example, the configuration of the pixel circuit 10 is not limited to the above-described example at all but other various configurations can be employed therefor. That is, the pixel circuit 10 may have any configuration as long as it has at least the light emitting element, the switching transistor Ts for inputting the signal value Vsig supplied to the signal line DTL, and the drive transistor Td for current application to the light emitting element dependent on the input signal value Vsig.

The setting of the pulse width or the H-level voltage of the scan pulse WS is made depending on the mobility of each unit, and various kinds of examples will be possible as specific examples of the setting.

For example, in the case of an example of setting the pulse width, the pulse width can be set on a unit-by-unit basis within a proper range in consideration of balance with the existence of the previous and subsequent pulses (periods for the threshold correction) and the horizontal cycle. Furthermore, in the case of an example of setting the H-level voltage, the H-level voltage can be adjusted within the range from the predetermined maximum voltage to the predetermined minimum voltage as the H level.

In addition, an example of setting the pulse width and the H-level voltage in a complex manner will also be possible.

Moreover, the examples in which the pulse width or the H-level voltage of the scan pulse WS is set on a unit-by-unit basis are employed for the embodiments. However, the pulse width or the H-level voltage may be so set as to differ depending on the mobility on a line-by-line basis irrespective of the units for example.

Furthermore, it will also be possible that different pulse waveforms are set for parts that are physically separate from each other although being the same unit (being annealed by the same laser head). For example, in FIG. 8, the part corresponding to the write control lines WSL1 and WSL2 and the part corresponding to the write control lines WSL7 and WSL8 are the same unit. However, different pulse waveforms may be set for these parts. That is, the setting of the pulse waveform of the scan pulse WS dependent on the mobility is not necessarily made on a unit-by-unit basis.

The present application contains subject matter related to that disclosed in Japanese Priority Patent Application JP 2009-093952 filed in the Japan Patent Office on Apr. 8, 2009, the entire content of which is hereby incorporated by reference.

It should be understood by those skilled in the art that various modifications, combinations, sub-combinations and alterations may occur depending on design requirements and other factor in so far as they are within the scope of the appended claims or the equivalents thereof.

What is claimed is:

1. A display device comprising:
a pixel array configured to include pixel circuits that are arranged in a matrix and each have at least a light emitting element, a switching transistor for inputting a signal value supplied to a signal line, and a drive transistor for current application to the light emitting element dependent on the input signal value;
a signal value output unit configured to output signal values given to the pixel circuits in the pixel array to the signal lines disposed on the pixel array; and
a write controller configured to give, to the pixel circuits on a line-by-line basis, scan pulses for carrying out conduction control of the switching transistor and inputting the signal value on the signal line to the pixel circuit, and allow the scan pulses given to lines to each have a pulse waveform set depending on mobility of the drive transistors in a corresponding one of the lines of the pixel array.

2. The display device according to claim 1, wherein
the lines of the pixel circuits included in the pixel array are subjected to laser annealing treatment by laser scan by use of a plurality of laser heads in a manufacturing process, and the mobility of the drive transistor is measured for each of units that are each composed of a plurality of lines subjected to the laser annealing treatment by the same laser head, and
the write controller carries out pulse waveform setting for the scan pulses for each of the units depending on the mobility measured for each of the units.

3. The display device according to claim 2, wherein
the write controller carries out pulse width setting dependent on the mobility as the pulse waveform setting for the scan pulses.

4. The display device according to claim 3, wherein
the write controller carries out such pulse width setting that a conductive time of the switching transistor for signal value input is longer in the unit in which the mobility of the drive transistor is lower and the conductive time of the switching transistor for signal value input is shorter in the unit in which the mobility of the drive transistor is higher.

5. The display device according to claim 2, wherein
the write controller carries out pulse voltage level setting dependent on the mobility as the pulse waveform setting for the scan pulses.

6. The display device according to claim 5, wherein
the write controller carries out such pulse voltage level setting that speed of writing of the signal value by the switching transistor is higher in the unit in which the mobility of the drive transistor is lower and the speed of writing of the signal value by the switching transistor is lower in the unit in which the mobility of the drive transistor is higher.

7. The display device according to claim 2, wherein
a monitoring transistor for mobility measurement is provided.

8. A display driving method of a display device having
a pixel array including pixel circuits that are arranged in a matrix and each have at least a light emitting element, a switching transistor for inputting a signal value supplied to a signal line, and a drive transistor for current application to the light emitting element dependent on the input signal value,
a signal value output unit that outputs signal values given to the pixel circuits in the pixel array to the signal lines disposed on the pixel array, and
a write controller that gives, to the pixel circuits on a line-by-line basis, scan pulses for carrying out conduction control of the switching transistor and inputting the signal value on the signal line to the pixel circuit, the method comprising the step of
by the write controller, setting a pulse waveform depending on mobility of the drive transistor for each of lines of the pixel array and giving the scan pulses each having the set pulse waveform to the lines.
